(19) United States
(12) Patent Application Publication
(10) Pub. No.: US 2004/0105450 A1
(43) Pub. Date: Jun. 3, 2004

(54) Camera system, camera device, and recording device

(75) Inventors: Isao Ikuta, Yokohama (JP); Tetsuo Nakano, Yokohama (JP); Shinya Imanishi, Yokohama (JP); Yutaka Igarashi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/442,384

(22) Filed: May 20, 2003

(30) Foreign Application Priority Data
Nov. 19, 2002 (JP) 2002-334480

(51) Int. Cl. H04B 1/66

(52) U.S. Cl. 370/401

(57) ABSTRACT

An image captured by a camera can be sent to and stored in a controller on a LAN as well as to a high-capacity camera with more memory than other camera devices on the LAN and to a camera on another LAN. This allows captured images to be recorded without losing the images even if an irregular event is detected and an irregularity takes place in the camera device at the site.

### BACKGROUND OF THE INVENTION

1. Field of the Invention

The present invention relates to a camera system, camera device, and recording device. More specifically, the present invention relates to the saving of an image captured by a camera device.

2. Description of the Prior Art

An example of a conventional method for storing images captured by a camera device is a system in which means for storing image data is installed on a network where image data can be freely retrieved from storage means (e.g., Japanese laid-open patent publication No. 2001-197473). In order to avoid restrictions resulting from the memory capacity of the camera device, images captured by the camera device are normally recorded in a storage region in storing means on the network.

### BRIEF SUMMARY OF THE INVENTION

In this conventional technology, the saved image data will be lost if there is a malfunction in the storage region of storing means.

The object of the present invention is to provide a camera system, camera device, and recording device that prevents loss of image data captured by a camera device even if there is an irregularity in storing means.

This object is achieved by the invention described in the claims.

### BRIEF DESCRIPTION OF THE DRAWINGS

FIG. 1 is a drawing showing the architecture of a monitoring network camera system according to a first, second, or third embodiment.

FIG. 2 is a drawing showing the internal architecture of a monitoring network camera according to the first or second embodiment.

FIG. 3 is a flowchart showing the control operations performed by a monitoring network camera according to the first embodiment.

FIG. 4 is a drawing showing the internal architecture of a monitoring network camera according to the third embodiment.

FIG. 5 is a flowchart showing the control operations performed by a receiving network camera according to the third embodiment.

FIG. 6 is a drawing showing the architecture of a monitoring network camera system according to a fourth embodiment.

### DETAILED DESCRIPTION OF THE INVENTION

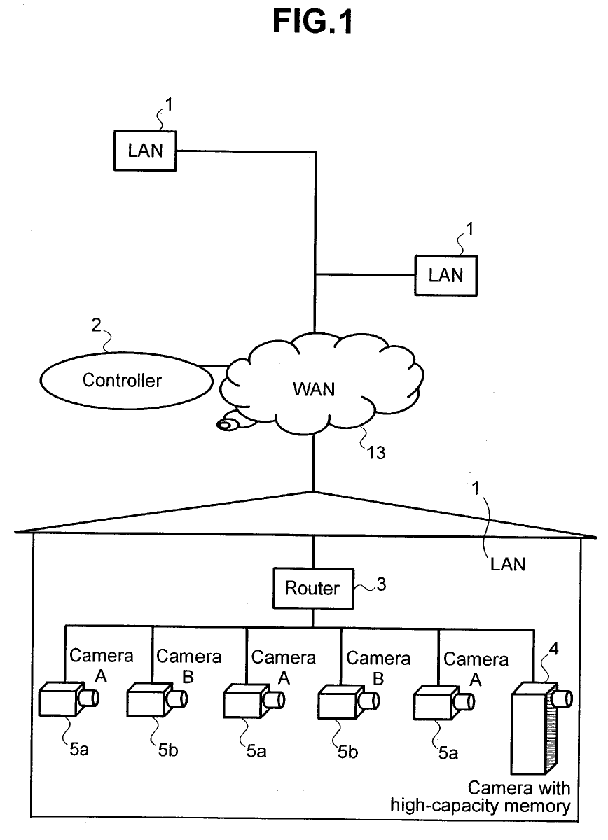

An embodiment of the present invention will be described, with references to the drawings. FIG. 1 show the architecture of a camera system according to a first embodiment of the present invention. The description of the first embodiment will omit description of the cameras 5b which serve as the cameras B in FIG. 1.

In this system, the cameras 5a shooting a site form a LAN (local area network) 1, and individual LANs are connected to a WAN (wide area network) 13, which is a network provided by a communications provider. A controller 2 is connected to the WAN 13 and performs operations such as displaying, recording, collecting, and managing image data received from the cameras 5a. The controller 2 can also be set up to perform real-time displaying and the like of image data received from the cameras 5a. The real-time displaying referred to here also covers delays corresponding to the time required to transfer and process data from the cameras 5a to the controller 2. The LAN 1 includes a router 3 connecting the cameras 5a to the network, the cameras 5a, and a high-capacity camera 4 equipped with memory having a higher capacity than those of the cameras 5a. The router 3 is equipped with a function for obtaining and updating at fixed intervals, in the form of an information table, the IP address and available space from each camera 5a in the LAN 1. In this system, if an irregularity is detected in at least one camera 5a or the high-capacity memory camera 4 on the LAN 1, the image captured by that 4 camera can be sent to the cameras 5a and the high-capacity camera 4 on the LAN 1, or the cameras 5a and the cameras 4 on other LANs 1, or the controller 2 by way of the WAN 13. If there is a communication irregularity with the controller 2, images can be sent to the cameras 5a and the cameras 4 that are not experiencing communication failures.

The irregularities referred to here are cases such as when communication with the controller 2 is not possible or when the communication status is busy due to an intruder in a building or premises, an in-store theft, or a natural disaster such as an earthquake, a volcano eruption, or a flood. Other cases that are considered irregularities include cases where images cannot be sent to the controller 2 or when no transmission completion notification is received after a predetermined interval following commencement of transmission.

It would be possible to have the image data sent to the controller 2 for displaying later, but it would also be possible to have the images received and displayed periodically at a predetermined time range. For example, by setting the system up for images to be received periodically at a time range in which communication is not congested, problems resulting from communication congestion can be avoided. Also, it would also be possible to have image data sent when necessary in response to an instruction from the controller 2.

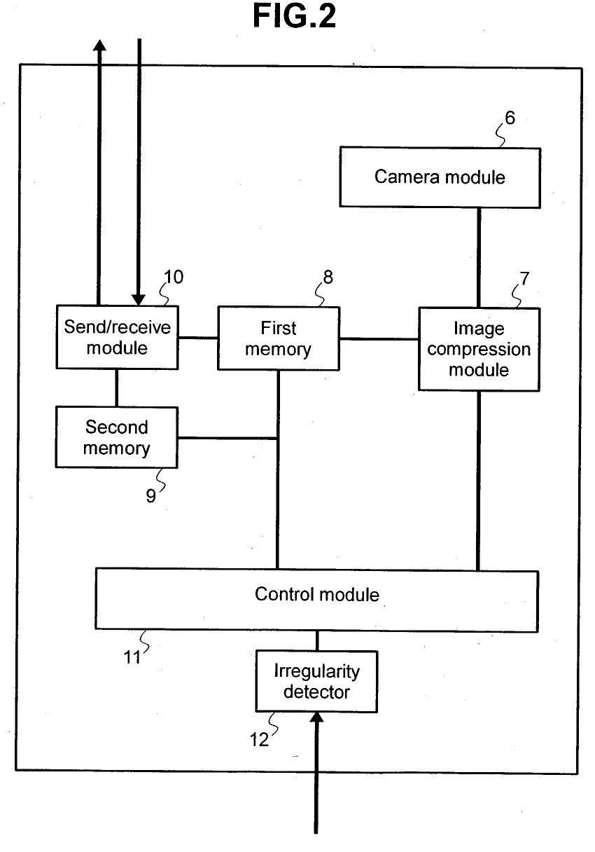

FIG. 2 shows the internal architecture of the camera 5a. The camera 5a is equipped with: a camera module 6 for capturing images; an images compression module 7 compressing captured images as image data; a first memory 8 recording and saving the image data; a second memory 9 recording and saving data received from the other cameras 5a; a send/receive module 10 sending image data captured and compressed locally and receiving image data from the other cameras 5a; a control module 11 controlling these modules; and an irregularity detector 12 having a function for evaluating irregularities in what is being monitored. In FIG. 2, the irregularity detector 12 is connected to the control module 11, but it would also be possible to have it connected with the send/receive module 10 to detect irregularities in communication status.

Examples of irregularity detection include: human-scale movement in the building or premises; in the case of in-store monitoring, obstruction in front of the camera for more than a fixed interval; a pre-set value being exceeded in an external sensor; and communication failure or a busy communication status. An example of a communication failure is when the communication line to the controller 2 is down.

It would also be possible to use an infrared sensor to detect irregularities when the camera device is moved, based on the images stored in the storage modules of the first memory 8 or the second memory 9 or the like.

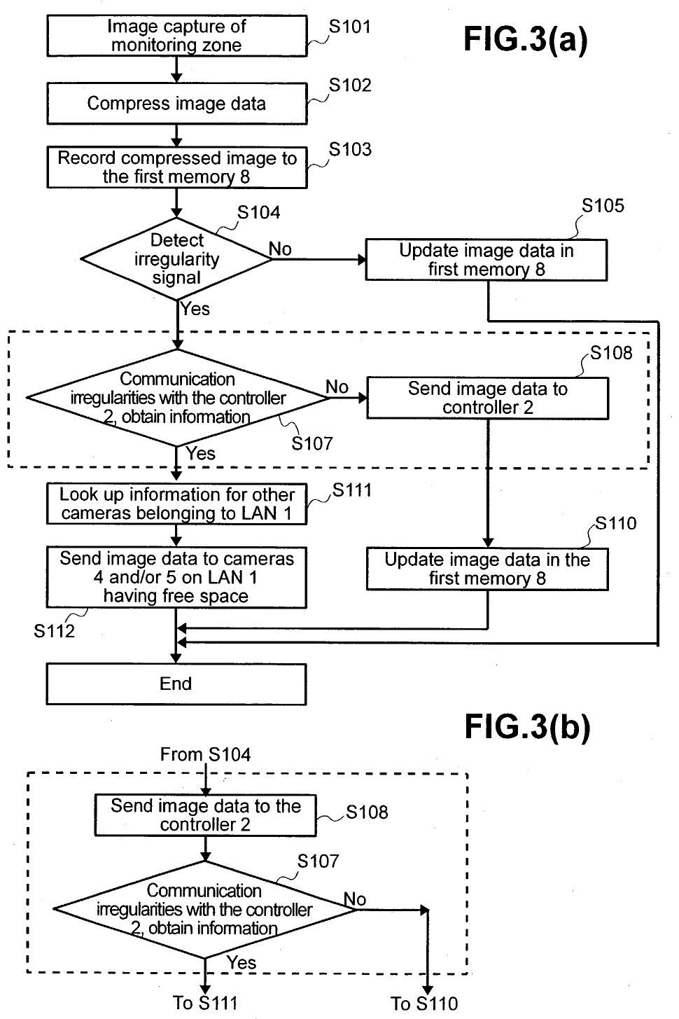

The control operations for the camera 5a will be described in detail using the flowchart shown in FIG. 3(a). The camera 5a captures the monitoring zone using the camera module 6 (S101). The captured image is compressed by the image compression module 7 to form image data (S102), which is then recorded/saved in the first memory 8 (S103).

If the irregularity detector 12 does not detect an irregularity signal (S104), the image data recorded in the first memory 8 of the camera is updated (S105).

If the irregularity detector 12 detects an irregularity signal (S104), the control module 11 checks for communication irregularities with the controller 2 by sending connection request data to the routers 3 on the network and obtains responses indicating the presence of irregularities from the routers. At the same time, an information table is retrieved from the second memory 9 indicating the IP addresses and available data space for the cameras 4 and/or 5a having available space. (S107).

If there is no communication irregularity with the controller 2 (S107), image data is sent to the controller 2 (S108). Also, the image data recorded in the first memory 8 is updated (S110). If there is a communication irregularity with the controller 2 (S107), a search is made for another camera 4 and/or 5a with available space using information held by the router 3 regarding IP address and available space information for the cameras 4 and/or 5a in the same LAN 1 (S111). The image data recorded in the first memory 8 is then sent to the camera 4 and/or 5a having available space (S112). Since the camera 4 is a high-capacity memory camera, it would be preferable to give priority to sending image data to the camera 4, but there is no problem sending to the cameras 5a. Also, it would be possible for the camera 4 and/or 5a to continue sending real-time image data to the controller 2 while the operations above are taking place.

The steps S104 and S107 provide two stages for detecting irregularities, but it would also be possible to omit the steps S104 and S105 and just provide one stage at S107 to detect irregularities in communication status with the controller 2. For example, communication may become impossible or the communication state may become busy. When this happens, the image data that could not be displayed by the controller 2 can be stored as an “insurance” measure.

When there is a communication irregularity with the controller 2 (S107), information at the router 3 is used to search for a camera 4 and/or 5a within the same LAN 1. However, this search does not have to be restricted to the same LAN 1, and it would be possible to prevent loss of image data by allowing use of the cameras 4 and/or 5a in other LANs 1 that are not experiencing communication irregularities. However, it would be preferable to give priority to the cameras 4 and the like within the same LAN 1 since it is relatively less likely that there will be communication failures with cameras 4 and the like within the same LAN 1.

Also, the section in FIG. 3(a) marked by the dotted line can be replaced with the section in FIG. 3(b) marked by the dotted line. In FIG. 3(a), the image data is sent to the controller 2 (S108) after it is determined that there is no irregularity in communication with the controller 2 (S107, No). In FIG. 3(b), the image data is sent to the controller 2 (S108) and then the presence of a communication irregularity with the controller 2 is evaluated (S107). More specifically, the operation to send to the controller 2 is performed, but if the image data could not be sent to the controller 2 due to an inability to establish communication or the like, control proceeds to step S111. If the image data could be sent normally to the controller 2, control proceeds to step S110. Control also proceeds to step S 111 in cases such as: after sending an image to the controller 2, the camera device does not receive a send completion notification from the controller 2 within a predetermined interval; the communication line between the camera 5a and the controller 2 is broken; and the like.

Also, the obtaining of address information for the cameras 5a can be done through the cameras 5a rather than through a router. Also, the first memory 8 and the second memory 9 are formed as separate memories, but it would be possible to record to separate regions within the same memory. It would also be possible add a flag to image data if the image data is being sent when there is an irregularity, thus allowing immediate identification of image data associated with an irregularity.

In this first embodiment described above, if the irregularity detector 12 of the camera 5a determines that there is an irregularity, a search is performed to find a camera 4 and/or 5a to which there is no network communication failure and which has available data capacity, and the post-irregularity image data is sent to this camera. Thus, the image data can be saved even if there is an irregularity in the storage of the controller 2 or if the camera 5a that detected an irregularity is subsequently destroyed. Also, even if there is a communication failure on the network, a camera 4 and/or 5a to which communication is possible is found and the image data is sent and recorded there. Thus, in a similar manner, the image data can be saved even if there is an irregularity in the storage of the controller 2 or if the camera 5a that detected an irregularity is subsequently destroyed.

Another advantage of this embodiment is that, compared to setting up a high-capacity memory separate from the cameras on the LAN 1, there is no need to set up a control system to accompany the high-capacity memory.

FIG. 1 also shows the architecture of a camera system according to a second embodiment of the present invention. This embodiment differs from the first embodiment in that the cameras 5b which serve as the cameras B are added. For the other sections, elements marked with same numerals as the first embodiment serve the same functions, so the corresponding descriptions will be omitted. The camera 5b continuously sends recorded image data to the camera 4 and/or 5b having available data capacity. Each camera 5b is connected on the LAN to the cameras 5a, the other cameras 5b, and the camera 4.

The points in which the operations of the camera 5b differ from those of the camera 5a will be described using FIG. 3(a). If no irregularity signal detection takes place at S104 (No), the camera 5a does not send image data to the camera 4 or the like. With the camera 5b, however, image data is sent to the camera 4 or the like even in these cases, and this image data is recorded by the receiving camera 4 or the like. As in the first embodiment, it would also be possible to add a flag to the image data being sent if there is an irregularity, thus allowing image data associated with an irregularity to be identified.

The camera 4 or the like that records the sent image records the image in the second memory 9, but this involves a large amount of relatively unimportant normal data that is not associated with irregularities. Therefore, the space taken up by image data from around the time of irregularities is not considered when determining whether there is available space in the second memory 9. If there is no available space due to image data from around the time of irregularities, the reception of image data is blocked. This way, the relatively important data from around the time of irregularities can be preserved without being overwritten, while the relatively unimportant normal data is overwritten, allowing efficient use of memory. Furthermore, since images are continuously sent to the secondary memory 9 of either the camera 4 or one of the cameras 5b, it would be possible to set up a system where functions and operations of the cameras 5a and the functions of the camera 5b are switched at periodic intervals.

In the second embodiment, the cameras 5a and the cameras 5b are used at the same time. Therefore, if an irregularity signal is generated due to destruction of a camera, the image data from the time of the irregularity will not be recorded is only the cameras 5a from the first embodiment are used. However, since the second embodiment uses the cameras 5b, which are sending image data prior to the irregularity, image data from around the time of the irregularity can be recorded.

In the second embodiment described above, images from around the time of an irregularity can be saved even if the camera at the site of the irregularity or the image recording storage unit in the controller 2 is destroyed.

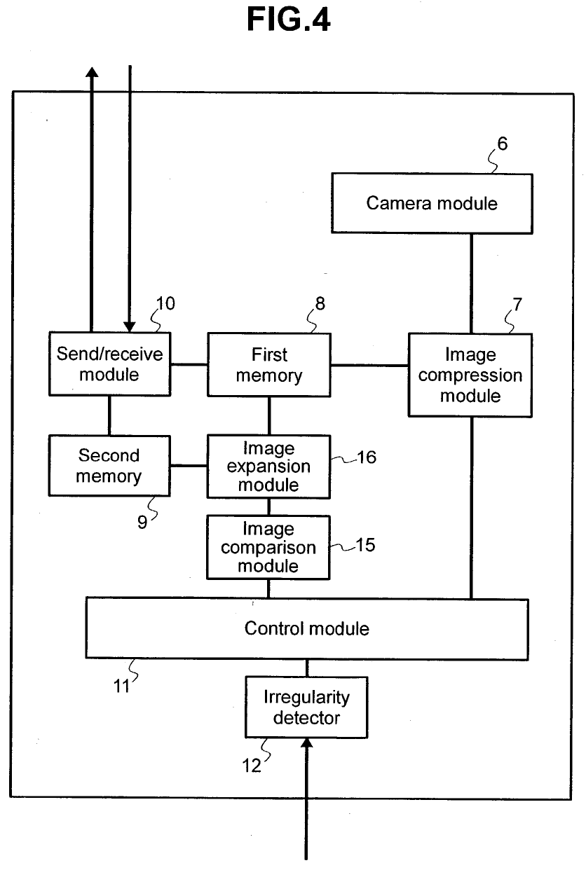

Next, a third embodiment of the present invention will be described. The system architecture is the same as that of the first embodiment. FIG. 4 shows the architecture of a camera in the third embodiment. This camera differs from that of the first embodiment in that the following elements are added: an image comparison module 15 comparing image received from the outside with image data of the local camera 5; and an image expansion module 16 expanding image data recorded in the first memory 8 and second memory 9 so that comparisons can be made by the image comparison module 15. The other elements serve the same functions as the elements from the first embodiment having like numerals, so the corresponding descriptions will be omitted. In this system, an image captured by the local camera 5a is compared with an image received from another camera Sa. If there is similarity, this can be notified to the external controller 2.

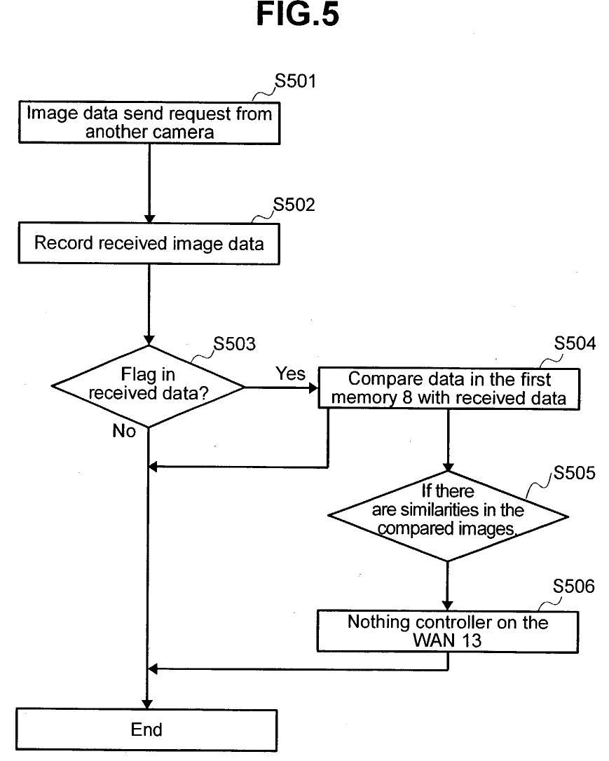

The control operations involved in the receiving of image data by the camera 5a will be described using the flowchart shown in FIG. 5. If another camera 5a sends an image data send request (S501), the received data is recorded (S502). If a flag is added (S503), image data stored in the first memory 8 and the second memory 9 is retrieved, image expansion is performed by the image expansion module 16, and the image data is compared by the image comparison module 15 (S504). If the compared images are similar (S505), the controller 2 for the WAN 13 is notified of the similarity (S506). Also, image data in which similarity was found can be sent to and recorded by all the other cameras as well.

The similarity referred to here indicates commonalities between people or animals or shapes or the like. An example of a method for evaluating similarities is pattern matching.

In the third embodiment described above, if the sensor of the camera 5a detects an irregularity signal, image data from the time of the irregularity is sent to all the cameras 4 and 5a on the LAN 1 having available space. The cameras 4 and the like receiving this data from the time of the irregularity compares the received image data with image data captured by the local camera 5a. If similarity is detected, the controller 2 is notified so that information from the time of an irregularity can be associated. Thus, for example, if a burglar who was involved in a theft in a store equipped with a camera 5a goes to a store equipped with another camera 5a, the second camera 5a will have obtained an image from the time of the irregularity from the first camera 5a and will notify the controller 2 due to the similarity of images. This allows the actions of the burglar to be known even if no theft was committed at the second store. Also, if a communication irregularity prevented notification of the controller 2, the image would be recorded by other cameras, allowing the actions of the burglar to be known and used as evidence.

In this case, image data is sent to all cameras on the LAN 1 with available space if an irregularity signal is detected. However, instead of sending to all cameras, it would also be possible to just send image data to one or a plurality of cameras.

The advantages of this configuration compared to installing a high-capacity memory unit separate from the cameras on the LAN 1 will be described. If a high-capacity memory unit separate from the cameras is installed on the LAN 1, determining whether a burglar who committed a theft in a store 1 entered another store 2 requires that the images captured by the camera 5a in the store 2 be continuously sent to the high-capacity memory unit or the controller 2. In this third embodiment, however, if a burglar commits a theft in a store 1 equipped with a camera 5a, this camera 5a will send images from around the time of the theft to the other cameras 5a. This makes it possible to determine if the burglar enters another store 2 equipped with one of the other cameras 5a.

Also, the second embodiment can be combined with the third embodiment. With this combination, it would be possible to record image data from around the time of an irregularity even if the camera 5a is destroyed before the theft. As a result, the image data of the burglar can be used to determine if there are similarities with other image data.

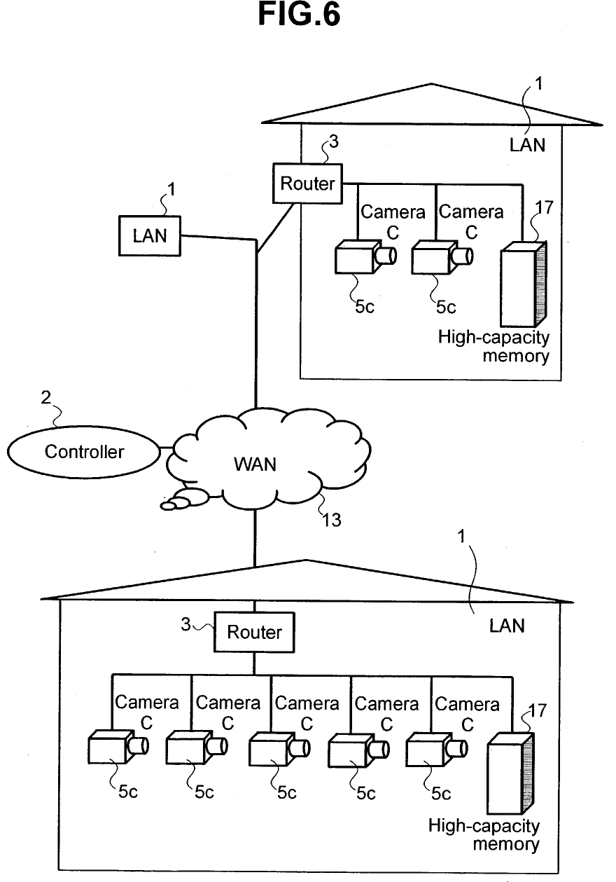

Next, a fourth embodiment will be described using FIG. 6. Elements labeled with the same numerals as those from the first embodiment serve the same functions, and the corresponding descriptions will be omitted. This embodiment differs from the first embodiment in that there is a high-capacity memory 17 that does not have camera functions. Also, the image data captured by the cameras 5c is recorded to the high-capacity memory 17, so the cameras 5c do not need to be equipped with memory.

Next, the operations performed by the fourth embodiment will be described. The camera 5c captures an image, and the captured image data is sent to the high-capacity memory 17. The sent image is recorded in the high-capacity memory 17. Then, if an irregularity signal is detected from the camera 5c, the high-capacity memory 17 sends image data from the time of the irregularity to the controller 2 is communication with the controller 2 is possible. If communication with the controller 2 is not possible, a LAN 1 to which communication is possible is found and the image data from the time of the irregularity is sent to the high-capacity memory 17 of that LAN 1.

In the fourth embodiment, even if there is no new storage unit separate. from LAN 1, image data captured from the camera 5c can be saved even if the controller 2 or high-capacity memory 17 on the LAN 1 where the camera 5c is located is destroyed.

In the embodiments described above, the networks are described as LANs or WANs. The present invention is not restricted to this, however, and any communication-capable system can be used. LANs and WANs are examples of “partial network” and “entire network” referred to in the claims. Also, independent LANs connected to a WAN are examples of “internal network” and “external network”.

Also, the first memory and the second memory can be removable. Also, it has been assumed that image data is being recorded, but the present invention can be implemented for the recording of audio data as well.

As described above, if a camera device detects an irregularity signal, image data is sent to and recorded in a camera device on a WAN or another LAN. As a result, when an irregularity takes place, image data can be recorded without being lost even if there is a controller on the WAN and there is a communication failure in the WAN.

Also, the system can be set up in an inexpensive manner since not all the cameras need to be equipped with large amounts of memory for recording images.

In the embodiments described above, all camera devices capturing images are equipped with memory. However, it would also be possible to have some camera devices not equipped with memory. This would allow low-cost camera devices and camera systems.

Image data from the time of an irregularity can be recorded without being lost even if the camera device detecting an irregularity signal is destroyed or if an irregularity takes place in the recording storage unit of the controller.

Furthermore, image data from the time of an irregularity can be sent to another camera device, which can then compare the received image data with image data that it captured and recorded. If a similarity is found, the information from when the irregularity took place can be associated with each other.

Also, since loss of image data captured by the camera device can be prevented, a more reliable camera system, camera device, and recording device can be provided.

The present invention makes it possible to provide a camera system, a camera device, and a recording device with improved reliability.

What is claimed is:

1. In a camera system equipped with a plurality of camera devices and a controller displaying images captured by the camera devices in real time, wherein at least one camera device comprises:
an imaging module;
an image compression module for compressing an image captured by the imaging module;
a storage module for storing an image compressed by the image compression module;
a control transmission module for sending in real time, an image stored in the storage module to the controller;
a camera transmission module for sending an image stored in the storage module to another camera device that is at least one of the plurality of camera devices, and wherein the another camera device stores an image sent from the camera transmission module.

2. A camera device as described in claim 1 wherein the camera transmission module sends an image when the control transmission module is unable to send an image to the controller.

3. A camera device as described in claim 1 wherein the camera transmission module sends an image when no send completion notification is received after a predetermined interval after sending was started from the control transmission module.

4. A camera device as described in claim 1 wherein the camera transmission module sends an image when a communication line between the camera device and the controller is down.

5. A camera device as described in claim 1 wherein:
the another camera device is equipped with an image comparison module comparing images to determine if there is similarity; and
the image comparison module compares the sent image with an image recorded by the another camera device and, if there is similarity, the similar images are associated and sent to a camera device other than the another camera device.

6. A camera device as described in claim 1 wherein:
the another camera device is equipped with an image comparison module comparing images to determine if there is similarity; and
the image comparison module compares the sent image with an image recorded by the another camera device and, if there is similarity, the controller is notified that there is similarity.

7. A camera device as described in claim 1 wherein the storage module has a storage capacity that is smaller than that of a storage module of the another camera device.

8. A camera system as in claim 1 wherein the controller periodically receives at predetermined time periods images captured by the camera devices.

9. A camera device as described in claim 8 further comprising an irregularity detection module detecting irregularities wherein the camera transmission module sends an image if an irregularity is detected by the irregularity detection module.

10. A camera device as described in claim 8 wherein:
the another camera device is equipped with an image comparison module comparing images to determine if there is similarity; and
the image comparison module compares the sent image with an image recorded by the another camera device and, if there is similarity, the similar images are associated and sent to a camera device other than the another camera device.

11. A camera system as in claim 1 wherein the control transmission module sends, in response to an instruction from the controller, an image. stored in the storage module; and the camera transmission module sends, without going through the controller, an image stored in the storage module to another camera device that is at least one of the plurality of camera devices.

12. A camera device as described in claim 11 further comprising an irregularity detection module detecting irregularities wherein the camera transmission module sends an image if an irregularity is detected by the irregularity detection module.

13. A camera device as described in claim 12 wherein:
the another camera device is equipped with an image comparison module comparing images to determine if there is similarity; and
the image comparison module compares the sent image with an image recorded by the another camera device and, if there is similarity, the similar images are associated and sent to a camera device other than the another camera device.

14. A camera device as described in claim 1 further comprising an irregularity detection module for detecting irregularities wherein the camera transmission module sends an image if the irregularity detection module detects an irregularity.

15. A camera device as described in claim 14 wherein the irregularity detection module detects irregularities when communication with the controller is not possible.

16. A camera device as described in claim 14 wherein the plurality of camera devices and the controller form a network.

17. A camera system equipped with a plurality of camera devices wherein at least one camera device comprises:
an imaging module;
an image compression module for compressing an image captured by the imaging module;
a storage module for storing an image compressed by the image compression module;
an irregularity detection module for detecting irregularities; and
a camera transmission module for sending an image stored in the storage module to another camera device that is one of the plurality of camera devices if an irregularity is detected by the irregularity detection module, and wherein the another camera device stores an image sent from the camera transmission module.

18. In a camera device that can be used in a camera system equipped with a plurality of camera devices, a camera device comprising:
an imaging module;
an image compression module for compressing an image captured by the imaging module;
a storage module for storing an image compressed by the image compression module;
an irregularity detection module for detecting irregularities; and
a camera transmission module for sending an image stored in the storage module to another camera device that is at least one of the plurality of camera devices if the irregularity detection module detects an irregularity.

19. A camera device as described in claim 18 wherein the irregularity detection module detects irregularities using an infrared sensor.

20. A camera device as described in claim 18 wherein the irregularity detection module detects irregularities by detecting when the camera device has been moved.

21. A camera device as described in claim 18 wherein the irregularity detection module detects irregularities based on an image stored in the storage module.

22. In a recording device that can be used in a camera system equipped with an internal network containing a recording device, an external network, and a controller, the internal network includes a plurality of internal camera devices, the recording device recording an image captured by the internal camera devices, and the external network includes a plurality of external camera devices and an external recording device recording an image captured by the external camera devices; a recording device comprising:
a recording module recording an image captured by the internal camera device;
a control transmission module sending an image recorded in the recording module to the controller; and
an external transmission module sending an image recorded in the recording module to the external recording device.

23. In a recording device that can be used in a camera system equipped with an internal network containing a recording device, an external network, and a controller, the internal network including a plurality of internal camera devices and the recording device recording an image captured by the internal camera devices, and the external network including a plurality of external camera devices and an external recording device recording an image captured by the external camera devices, a recording device comprising:
a recording module for recording an image captured by the internal camera device;
an irregularity detection module for detecting irregularities; and
a transmission module for sending to the external recording device an image recorded in the recording module if the irregularity detection module detects an irregularity.
